(19) United States
(12) Patent Application Publication
(10) Pub. No.: US 2014/0064260 A1
(43) Pub. Date: Mar. 6, 2014

(54) METHOD, SYSTEM AND ARTICLE FOR WIRELESS DEVICES TO DISCOVER AND CONNECT TO OTHER DEVICES

(71) Applicants: Brian E. Mastenbrook, Schaumburg, IL (US); Matthew H. Klapman, Northbrook, IL (US)

(72) Inventors: Brian E. Mastenbrook, Schaumburg, IL (US); Matthew H. Klapman, Northbrook, IL (US)

(21) Appl. No.: 14/015,272

(22) Filed: Aug. 30, 2013

Related U.S. Application Data
(60) Provisional application No. 61/696,070, filed on Aug. 31, 2012.

(51) Int. Cl. H04W 8/00; H04W 76/02

(52) U.S. Cl. CPC H04W 8/005; H04W 76/023
USPC 370/338

(57) ABSTRACT

Methods and systems are disclosed for a first wireless device to select a wireless network connection to a second wireless device. The wireless network may be a wireless local area network (WLAN), such as a Wi-Fi network. To make its selection, the first wireless device detects a beacon signal transmitted from the second wireless device. The beacon signal including a media access control (MAC) address. The first device then applies a set of programmable rules to at least a portion of the MAC address, and selects the second wireless device based on the application of the rules. The rules may also/alternatively be applied to parameters, for example, sensory inputs, such as time and date, temperature, light intensity or user actions (e.g., screen swipes, button pushes), that are immediate or recorded in a database, whereby certain patterns are matched in order to make the selection.

### CLAIM OF PRIORITY UNDER 35 U.S.C. §119

The present Application for Patent claims priority to Provisional Application No. 61/696,070; entitled “Method for Devices to Discover and Connect Optimally,” filed Aug. 31, 2012, and hereby expressly incorporated by reference in its entirety as though set forth fully herein.

### TECHNICAL FIELD

The present disclosure relates generally to wireless networking, and in particular, to new and improved techniques for wireless devices to detect and connect to one another.

### BACKGROUND

Connecting wireless devices to each other is not always a straightforward or simple task. For consumers, common wireless technologies for connecting two smart devices together include Bluetooth or Wi-Fi, IEEE standard 802.11.

Bluetooth requires working through a “pairing” mode to initially connect the devices.

For Wi-Fi, a wireless device is typically connected to a wireless router. The wireless router then enables the connected device to connect to other devices. When a wireless router is not available, Wi-Fi Direct can be used, but this standard has not yet become widely used.

In known Wi-Fi enabled devices, the devices' operating systems are designed to handle selection of Wi-Fi networks under the premise that such networks provide Internet access. The conventional process of connecting a wireless mobile device to a Wi-Fi network comprises the following steps:

1) A Wi-Fi transceiver in the mobile device is powered on. A user may enable a device control, which controls whether Wi-Fi networking may be used on the wireless device.

2) After being enable, the device's Wi-Fi transceiver starts a periodic scanning process that searches for wireless networks by listening for the Wi-Fi “beacon” signal, which contains a network name and identifying Media Access Control (MAC) address which is unique to the wireless network. The identifying address consists of at least two components: an Organizationally Unique Identifier (OUI), and the specific address of the device. The OUI contains a bit identifying whether it is globally unique, in which case it is a manufacturer/issuer-specific identifying address issued by the IEEE. If the bit is not set, the OUI is marked as “locally administered”, which does not have a well-defined meaning under IEEE Wi-Fi standards.

3) A list of saved and scanned networks is created by the wireless device, listing candidates for automatic Wi-Fi network selection when the Wi-Fi transceiver is enabled and no network is currently joined.

4) The wireless device provides an interface that allows the user to select a network from the list of saved and scanned networks. After the user makes a selection, the device attempts to connect to the selected network after credentials (if necessary), e.g., password, key phrase or the like, have been supplied by the user or device. When the device connects to the network, the wireless device may add the network to the list of saved networks.

Known methods of connecting to wireless networks present certain limitations, particularly where portable devices attempt to connect to each other directly without use of a wireless router. Thus, there is a need for improved methods and techniques for wirelessly connecting wireless devices to one another.

### BRIEF DESCRIPTION OF THE DRAWINGS

It is to be understood that the drawings are solely for purpose of illustration and do not define the limits of the appended claims. Furthermore, the components in the figures are not necessarily to scale. In the figures, like reference numerals designate corresponding parts throughout the different views.

FIG. 1 is a conceptual block diagram illustrating certain components of an exemplary wireless networking system.

FIG. 2 is a flowchart illustrating an exemplary method for connecting wireless networked devices, such as those included in the system of FIG. 1.

FIG. 3 is a flowchart illustrating an exemplary “follow me” networking method that can be employed by the system of FIG. 1.

FIG. 4 is a flowchart illustrating an exemplary power saving method that can be employed by the system of FIG. 1.

### DETAILED DESCRIPTION

The following detailed description, which references to and incorporates the drawings, describes and illustrates one or more specific embodiments of what is claimed. These embodiments, offered not to limit but only to exemplify and teach the invention, are shown and described in sufficient detail to enable those skilled in the art to practice the invention defined by the claims. Thus, where appropriate to avoid obscuring the invention, the description may omit certain information known to those of skill in the art. The embodiments disclosed herein are examples that should not be read to unduly limit the scope of the claims.

The word “exemplary” is used throughout this disclosure to mean “serving as an example, instance, or illustration.” Any embodiment or feature described herein as “exemplary” is not necessarily to be construed as preferred or advantageous over other embodiments or features.

The embodiments described herein may automate and/or enhance the process of connecting a wireless mobile computing device (WMCD) (e.g., a cellular phone, smartphone, tablet, laptop, or the like) to a wireless information serving device (WISD) through a wireless network, such as Wi-Fi. The WISD may be another Wi-Fi enabled WMCD or a wireless server, such as an AirStash® device, for example, any of the devices described in U.S. Pat. No. 8,527,719, which is hereby expressly incorporated by reference in its entirety as though set forth fully herein. The roles of the WMCD and WISD may be implemented in other devices, such as laptops and a mobile hotspot/MiFi style devices, tablets, or wireless sensor devices.

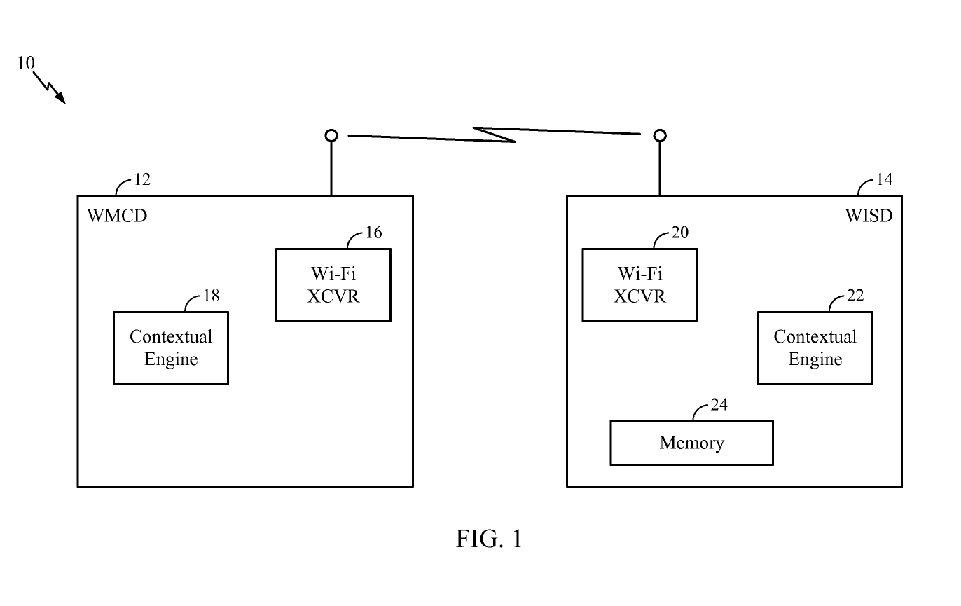

FIG. 1 is a block diagram illustrating certain components of an exemplary system 10 including examples of a WMCD 12 and a WISD 14. Generally, the system 10 includes at least two wireless devices (WMCD and WISD 12, 14) that are to be connected. The system 10 may include more than two wireless devices that are to be connected. While each device 12, 14 may have the same capabilities as the other or different capabilities, one device will take the role of a server and the other will take the role of a client. The server device will create a wireless network and allow the client or multiple client devices to connect to it. It can also act as an access point and broadcast standard beaconing signals to communicate with other wireless devices. While other wireless network standards can be utilized, the IEEE 802.11 Wi-Fi standard is preferred.

The WMCD 12 may be a programmable device that includes memory (not shown) for storing executable software/firmware for performing any of the methods described herein and one or more processors (not shown) for executing the software/firmware. The WMCD 12 may include a commercially-available operating system (OS) for performing some of the functions described herein. The WMCD 12 includes a Wi-Fi transceiver (XCVR) 16, which typically can be connected to one wireless network at a time, and a contextual engine 18. It also may contain a cellular radio (not shown). Either the Wi-Fi transceiver 16 or cellular radio can be used to connect to the Internet.

The WISD 14 may be a programmable device that includes memory (not shown) for storing executable software/firmware for performing any of the methods described herein and one or more processors (not shown) for executing the software/firmware. The WISD 14 may include a commercially-available operating system (OS) for performing some of the functions described herein. The WISD 14 contains a Wi-Fi transceiver (XCVR) 20, which can create a wireless network and which can also connect to another independent wireless network simultaneously. The WISD 14 may also include a contextual engine 22 and memory 24, such as a memory card. The memory 24 may be accessed by the WMCD, as described infra.

The mode in which the WISD 14 creates its own wireless network is referred to as a server mode. The mode in which the WISD 14 joins an independent wireless network as a client is referred to as client mode. One or both of these modes may be active at the same time.

The contextual engines 18, 22 are each state machines that may be implemented as software stored, respectively, in a memory (not shown) included in each device 12, 14 and executed by a processor (not shown) also included in each device 12, 14.

Each contextual engine 18, 22 is a state machine that makes wireless network selections and/or changes wireless network settings or groups of wireless network settings based upon a set of rules set by a either one or a combination of the following: third parties, the current user, other users, other remote devices. The rules may be applied to parameters, for example, sensory inputs, such as time and date, temperature, light intensity or user actions (e.g., screen swipes, button pushes), that are immediate or recorded in a database, whereby certain patterns are matched. Other information and parameters, such as information regarding a wireless device/network that is a potential candidate to connect to (such parameters and information may be stored in a database) may be used by the rules to make selections. Such parameters may include, but are not limited to, current operational parameters, such as signal strength, broadcast frequencies, device type or the like, or other information that may be part of a transmitting device's MAC address or transmitted MAC packets. Other information may be used by the contextual engine rules to make its settings or selections, for example, information about other state machines, such as the state of other applications running on a device, the state of other components in the device or system, including the state of connectivity, device battery energy remaining, allocated/free memory or the like. As used herein, when a networking decision is based upon context, it means that a contextual engine was utilized.

Connect and Disconnect Processes

The following methods described herein for connecting and disconnecting the WMCD 12 to the WISD 14 can be accomplished through an application program installed on the WMCD 12. This program manages the connection process to the WMCD 12. The program does not necessarily replace the WMCD's built in methods and programs for connecting to Wi-Fi networks.

The program includes two components: a “service” process that runs in the background to help manage the connection and which monitors changes in the Wi-Fi network state of the WMCD 12, and a user-facing application or interface process which appears to the user in the list of application programs installed on the WMCD 12. The program implements, at least in part, the contextual engine 18.

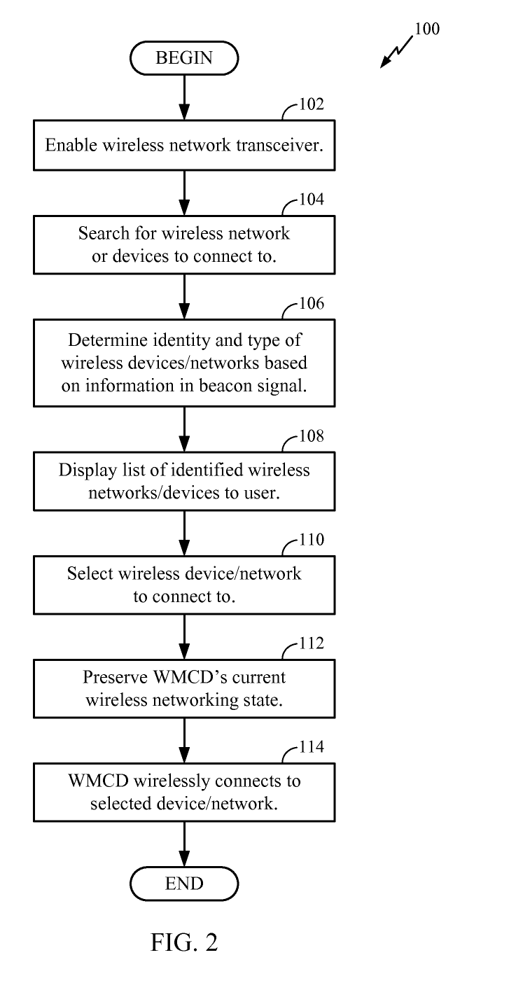

With the WISD 14 turned on and broadcasting Wi-Fi beaconing signals within range of the WMCD 12, the WMCD 12 can perform the connection method 100 shown in FIG. 2.

In step 102, if the application program is run and the WMCD's Wi-Fi transceiver 16 is powered off, the application will first prompt the user if he or she wishes to enable Wi-Fi networking on their device 12. The prompt may appear on a touch display screen included in the WMCD 12. If the user approves, the previous state of the Wi-Fi transceiver is stored in the WMCD 12 for use during the Wi-Fi disconnection process.

Next, in step 104, the WMCD 12 searches for wireless networks within range, such as a wireless network established by the WISD 14. The search can be done using conventional Wi-Fi methods for scanning and detecting Wi-Fi beacon signals.

In step 106, candidate wireless networks are determined by the WMCD 12, based upon any suitable combination of the following factors: 1) a network Media Access Control (MAC) address; 2) a service set identifier (SSID); and/or 3) other information broadcast from the network server. The SSID may be user configurable.

The WMCD 12 can determine the identity and type of wireless network by examining the network's MAC address broadcast in the Wi-Fi beacon signal. For example, the WMCD 12 can compare the Organizationally Unique Identifier (OUI) of the broadcast MAC address to a database of stored OUIs to match the network to a particular device, provider, manufacturer, display icon or the like. The database may act as a lookup table. The database may be stored locally on the WMCD 12, or remotely, for example, on a server accessible to the device 12 by way of the Internet.

In step 108, a list of identified candidate networks is presented to the user on the display of the WMCD 12. Icons corresponding to the candidate networks or devices providing the network services can be displayed, where the icons are stored or referenced as part of the database and selected based on the OUI detected for the corresponding wireless network or server device.

In step 110, a wireless network or server device is selected by the WMCD 12. The selection can be automatic, manual or a combination of the two. Automatic selection may be accomplished by the contextual engine 18 picking a subset of devices/networks based upon context, settings, usage, rules and information from the MAC address and/or database. One or more devices/networks may be automatically selected for connecting to in this manner. If automatic selection is used, step 108 may be omitted.

The contextual engine 18 may also implement partial automatic selection, where the automatic method above may be used to reduce the number of selections presented to the user in step 108, and then the user makes a final selection manually, for example, using a touch screen. A manual method involves the user selecting a device/network from the displayed list, without assistance from the contextual engine 18.

In step 112, the WMCD's state is preserved. This typically involves preserving or storing the any current wireless connection information and wireless priority settings.

In step 114, the WMCD 12 wirelessly connects to the selected wireless device/network.

The service component of the application program in the WMCD 12 monitors whether the Wi-Fi transceiver 16 of the WMCD 12 is enabled, and if it is, whether it is currently connected to a Wi-Fi network and the details of the network it is connected to. When the WMCD 12 connects to a network, the service determines whether the network is created by the WISD 14 by examining Wi-Fi MAC address broadcast by the WISD 14. If the OUI matches the address assigned to a particular vendor, the network is assumed to be the WISD 14 operating in server mode. The device identifying part of the MAC address may be used to determine the particular model of the WISD 14. Information in the SSID or in other parts of the wireless network beacon signal may be also/alternatively used to identify the current network connection.

If the currently connected wireless network is created by the WISD 14, the service component of the application presents a notification to the user that the WMCD 12 is connected to the WISD 14. In the implementation of this technique on the Android operating system, this is accomplished by adding a notification to the system notification tray.

If the user runs the application while the WMCD 12 is already connected to the WISD 14 in server mode, the application displays the contents of the memory 24 of the WISD 14 and allows the user to interact with the memory 24, for example reading or storing information on the memory 24.

If the user runs the application and the WMCD 12 is not connected to the WISD 14 network, the application may initiate a scan for nearby Wi-Fi networks. As results are found, they are examined by the service component of the application to determine if they are WISD 14 networks. Matching networks are added to a list of networks/devices displayed to the user on the WMCD 12, which shows the name of the network, the signal strength, and an icon indicating that the device is a WISD. When possible, the device identifying part of the MAC address is used to determine the particular model of the WISD 14 and an appropriate icon is selected in order to provide an accurate visual representation of the WISD 14 on the WMCD 12.

If the WMCD 12 is connected to a Wi-Fi network which is not created by the WISD 14, the application also queries the current Wi-Fi network to determine if any WISDs 14 in client mode are connected to the Wi-Fi network. If any such WISDs are found, they are added to the list, and the wireless networks created by these WISDs are removed from the list or unified with the list entry showing the WISD in client mode. The application may prompt the user on selection of one of these devices whether the user wishes to connect to the WISD 14 device in client mode or server mode.

If the user selects the WISD 14 from the list of devices while the WISD 14 is in client mode, any current Wi-Fi network connection of the WMCD 12 is maintained, and the application allows the user to interact with the WISD 14 through its client mode connection to the Wi-Fi network. The user may return to the list of WISD devices at any time.

If the WMCD 12 is connected to a Wi-Fi network that provides Internet access or is connected to the Internet through a mobile cellular network, additional information about nearby WISDs may be available by way of the Internet. For example, the WMCD 12 may be connected to a Wi-Fi network A, and may be in range of the separate network B. The WISD 14 may be connected in client mode to network B. The WISD 14 may communicate with an Internet server through network B to provide information about the Wi-Fi network it is connected to. The WMCD 12, having previously registered with the same Internet server and provided the credentials necessary to view connection information about the Wi-Fi network that the particular WISD 14 device is connected to, may retrieve this information through its Internet connection via network A. The network B can then be added to the Wi-Fi network selection list of the WMCD 12, as connecting to this network would provide access to the WISD 14. If the user selects network B from the list of wireless network/devices, the application will cause the WMCD 12 to connect to the network B as if the user initiated this connection from the system list of Wi-Fi networks, then attempt to connect to the WISD 14 device on network B.

When the user chooses to connect to the WISD 14 while the WISD 14 is in server mode, through the device/network selection list presented by the application, the identity of any currently connected Wi-Fi network is stored, if it is not also another WISD. The application then directs the WMCD 12 to disconnect from its currently connected Wi-Fi network. Once the current network has been disconnected, the application then initiates a connection to the WISD 14 network. If the network is present in the WMCD saved list of network connections, the connection will use the credentials from the saved list. If it is not present in the list of saved connections, the user will be prompted for authentication credentials (if applicable), and the network will be added to the WMCD saved list. Once the WMCD 12 is connected to the WISD 14 in server mode, the application will allow the user to interact with the WISD 14.

While the WMCD 12 is connected to the WISD 14, persistent (such as an icon in a tray) or periodic notification may be displayed to the user by the application program, indicating that the WMCD 12 is connected to the WISD 14.

During the connected state, the WMCD 12 may also collect meta-data about the currently connected WISD 14, including information about the WISD's services and capabilities using, for example, known methods such as Bonjour. Other methods may be used to gather the meta-data during the connection. Storing this information in the WCMD 12 can help make better decisions regarding future connections and methods of presentation to the user and automatic connections.

When the WMCD 12 is connected to the WISD 14 in server mode, there are several different situations in which it can become disconnected. These situations can be classified according to whether they are initiated from the WMCD 12 or from the WISD 14, and by whether they are explicitly user-initiated or controlled by some automatic process implement by the application program or contextual engine 18.

Disconnection can occur from any client or server device whether intentional or unintentional (external factors occur such as loss of signal) and can be initiated from either side, then executed by the same side or the other side.

Different types of disconnect include a manual user disconnect whereby a user initiates a disconnect, whether on the client (their connected device, e.g., the WMCD 12) or on the server, e.g., the WISD 14, by either:
1. Explicitly initiating a disconnect (through menu and/or notification selection), or
2. Implicitly disconnecting by choosing a new device and initiating a connection to it.

An automatic disconnect may occur when: 1) a device timer expires, 2) a device is out of range, 3) geo-fencing triggers the device, and/or 4) other contextual information causes a contextual engine to initiate a disconnection.

After a disconnection, the WMCD 12 may mark the network being disconnected as a network that should not be rejoined automatically, and then utilize a contextual algorithm to make the decision to either restore the previously stored connection and override any built-in prioritization connection algorithm, or allow the device to run its built-in Wi-Fi connection algorithm.

Whenever the WMCD 12 becomes disconnected from the WISD 14 while it is in server mode, the WISD network identity is retained in the list of WMCD-saved Wi-Fi connections; however, it is explicitly marked as disabled so that it is not considered as a candidate for automatic wireless network selection by the WMCD 12 at a later time. This “disabled” flag does not prevent the network from appearing in the list of WISDs presented by the application to the WMCD user. Disabling the WISD 14 network and preventing it from being considered an auto-connection candidate prevents the WMCD 12 from automatically connecting in situations where the user would prefer to receive Internet access over a separate Wi-Fi network, rather than interacting with the WISD 14.

Setting the disabled flag occurs regardless of the cause of the disconnection, including when the WMCD 12 is connected to one WISD 14 network and the user selects a different WISD 14 network from the list of WISDs presented by the application.

The process of setting the disabled flag is performed by the service component of the application running on the WMCD 12. Because the disabled flag is set whenever a disconnection occurs, the only time the WISD 14 network is not “disabled” is when the WMCD 12 is connected to that network.

The user of the WMCD 12 may manually initiate a disconnection from the WISD 14 by selecting the notification that is displayed by the WMCD 12 when the WMCD 12 is connected to the WISD 14. A manual disconnection can also occur when the user specifically turns off Wi-Fi networking on the WISD 14 by holding its power button. When the WMCD 12 is disconnected from the WISD 14 as a result of manual initiation, or as a result of an automatic process, the WMCD 12 may automatically run its built-in Wi-Fi network selection algorithm to choose a new Wi-Fi network to connect to. Before this process occurs, the application determines if it has remembered a previously connected Wi-Fi network as described above. If such a network has been remembered and is still in range of the WMCD 12, the application attempts to initiate a connection to this network, overriding the built-in Wi-Fi network automatic selection behavior of the WMCD 12.

If a disconnection is manually initiated by selecting the Wi-Fi notification displayed by the application on the WMCD 12, and the WMCD 12 Wi-Fi transceiver had previously been powered off, the application may prompt the user if he or she wishes to turn off wireless networking power to restore the previous Wi-Fi state of the WMCD 12.

Automatic disconnection can occur as a result of a system inactivity timer which powers off Wi-Fi networking on the WISD 14 to preserve battery power.

If a disconnection occurs as a result of an explicit user-initiated network change (such as selecting a different wireless network from the WMCD's system list of wireless networks) or because the user has turned off the Wi-Fi transceiver power on the WMCD 12, the WISD 14 network is still marked as disabled, but the application does not attempt to override the new network connection (if applicable). Additionally, any remembered previous network or transceiver power status is forgotten when this occurs.

In client mode, the WISD 14 connects to a wireless network that a WMCD 12 may also be connected to in order to allow the WMCD 12 to access both the Internet and the contents of the WISD memory 24. The WISD 14 contains its own list of saved wireless networks and performs an automatic network selection process in order to connect to these networks. The user adds networks to the list of saved networks by connecting their WMCD 12 to the WISD 14 in server mode and then selecting a new network to add to the WISD 14 saved list.

Client mode may not always provide access to the WISD 14 when the WMCD 12 and WISD 14 are within wireless networking range of each other. The automatic Wi-Fi network selection process performed on the WISD 14 may not choose the same network that the WMCD 12 is connected to. In this situation, it may be possible to have the WMCD 12 change which network it is connected to in order to access the WISD 14 as described above; however, it may be preferable to have the WISD 14 change its current network connection. Alternatively, the WMCD 12 may be connected to a network which is not in the saved list of the WISD 14. A “follow me” mechanism that allows the WISD 14 to change its client mode network connection to match that of the WMCD 12 provides a solution to these issues.

Follow Me Mode

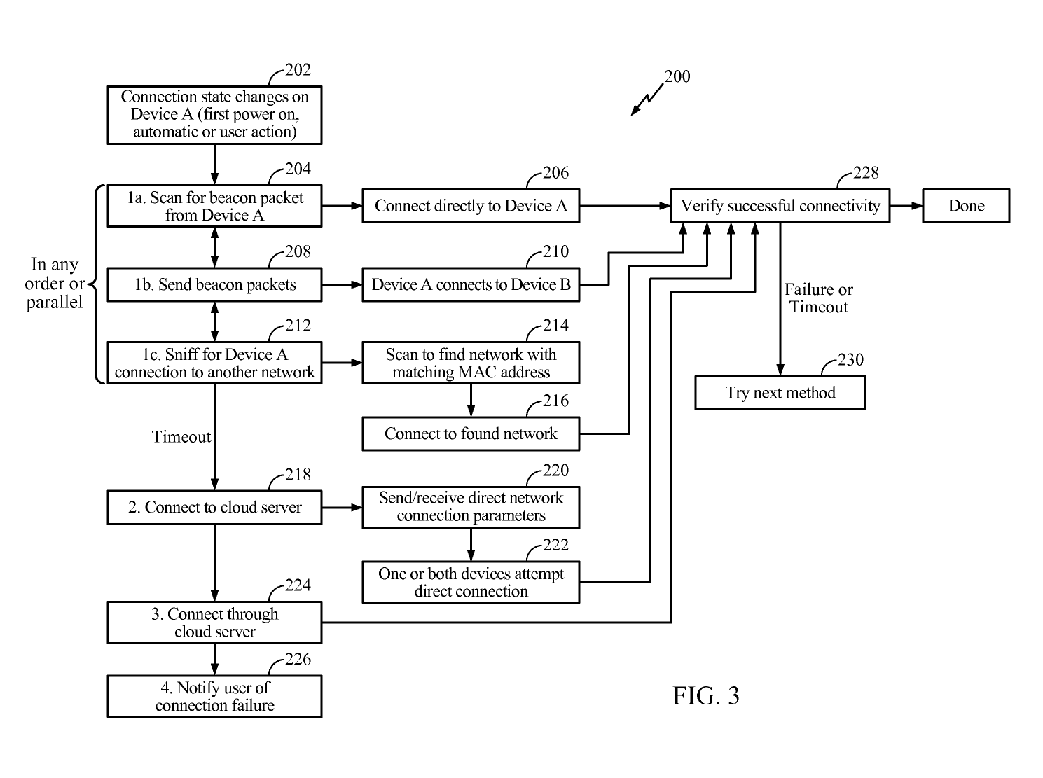

FIG. 3 shows a flowchart of a follow-me mode method 200. The “follow me” mechanism allows wireless devices to intelligently migrate to a new Wi-Fi network together. In the event that a device, for example, the client device (can be server device as well), connects to a different Wi-Fi network than the server device (can be another client device as well), or if the server (can be a client device) is just turned on and not connected to any network, then it is desirable for the non-connected or other devices to discover what network the other devices are on (can be a master device, a plurality of devices, or other contextual decision) and connect to the same network as the other device(s), whether a primary or secondary network (for example the first network is a third party network and the secondary network is a direct connection).

The wireless connections between devices can be at least: 1) the devices are connected directly to each other (a peer-to-peer connection between devices), 2) the devices are connected to a local third party network (e.g., both connected to a local router), or 3) the devices are connected to different third party networks.

With the three different types of connections, in the event that a device (Device A) is not the same network as another device (Device B), whether because one device (Device A) was just powered up, brought into range, or was changed to another network, then another device (Device B) may attempt to connect to the other device (step 202). Based upon the three types of connections between devices given above:

1. Device B can scan for Wi-Fi beacon packets from Device A (step 204) and connect directly to device A (step 206) in the event that Device A acts as an access point.

2. Device B can attempt to connect to Device A by passively sending out a beacon to signal Device A (step 208), and then Device A connects to Device B, where Device B is the server (step 210).

3. If Device A has changed to a different local network, then Device B can sniff the unencrypted portion of in-range wireless packets and search for the known MAC address of Device A (step 212). When it finds the packets with the Device A MAC address, it can determine what network it is connected to by looking at the destination address in the MAC address (step 214) and then attempt to join that other network (step 216) using the destination address.

4. If Device A is on one network and Device B is on another network, but both networks are connected to the Internet, then Device B can communicate to Device A through a cloud server. This is a known method for devices to communicate; however, this may not be an optimal way to connect, so it is novel to discover and negotiate a more optimal connection method (step 218). Device B can query the cloud server which can act as a router to communicate to Device A or can contain a database about Device A. A contextual decision can be made on how to best connect in other ways than through the cloud server. For example, if it is determined that both Device A and Device B can connect to a similar local network, then the proper parameters would be sent to one or both of the devices (step 220) to have each or one connect to the same local network as the other device (step 222). This local network can be a third party network or even a direct connection between the devices.

In step 228, the success of the connections is verified by successful transmission between Device A and B. If the transmission fails or times out, one of the other processes in 1-4 above may be attempted by Devices A and B (step 230). If none of the processes 1-4 are successful, the user is notified of a follow me mode failure (step 226).

With respect to the system 10 of FIG. 1, the “follow me” feature consists of two independent mechanisms; one is initiated by the WISD 14, and another is initiated by the WMCD 12. When initiated by the WISD 14, the WISD 14 attempts to determine which network the WMCD 12 is connected to and configure its connection to match. In order to identify this network, the WISD 14 watches for wireless network packets sent from the identifying MAC address of the WMCD 12, which has been previously saved to the WISD 14 as a result of a “pairing” process which occurs within a server mode connection.

When the WISD 14 sees a packet sent from the WMCD 12, it looks at the destination MAC address of the packet to determine which Wi-Fi network the WMCD 12 is connected to. If this MAC address matches a network which has been saved to the WISD 14, or matches a network whose beacon information has been received by the WISD 14 and which indicates that the network does not require authentication, the WISD 14 can attempt to connect to this network. In order to ensure that packets from the WMCD 12 can be seen by the WISD 14, the WISD 14 application program will periodically send packets to the currently connected Wi-Fi network when the application is showing the Wi-Fi network selection screen.

When the “follow me” feature is initiated by the WMCD 12, the WMCD 12 is responsible for informing the WISD 14 about the details of the Wi-Fi network that the WMCD 12 is currently connected to. If the WMCD 12 is connected to a Wi-Fi network which requires authentication and whose credentials are not currently saved in the WISD 14 network list, the WMCD 12 may be able to communicate these credentials to the WISD 14 using Wi-Fi messages.

If the WISD 14 is connected to a different Wi-Fi network in client mode than the current Wi-Fi connection of the WMCD 12, then the WMCD 12 may be able to communicate information about its current network connection through the Internet. If the WISD 14 is not currently connected to a Wi-Fi network in client mode, but instead its server mode connection is within range of the WMCD 12, the application on the WMCD 12 may initiate a connection to the WISD 14 in server mode to send information about the WMCD's 12 connection to the WISD 14. After the information is sent, the previous Wi-Fi connection of the WMCD 12 can be restored.

Power Saving Mode

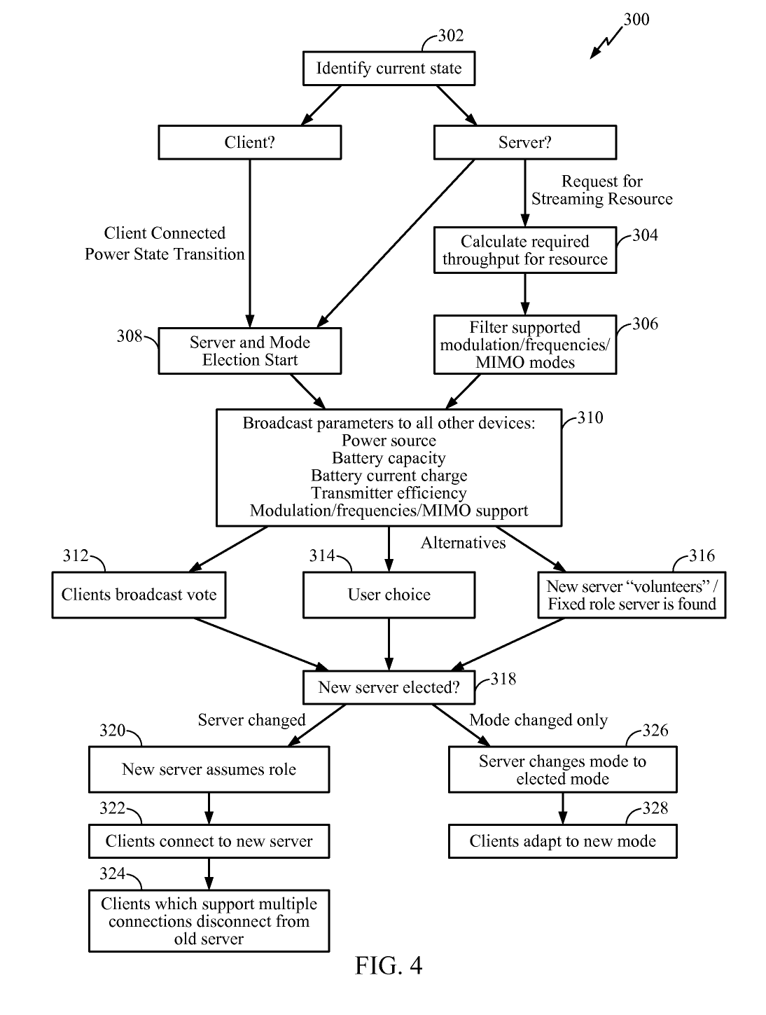

FIG. 4 is a flowchart of a power saving mode method 300. Using this method, two or more devices may exchange roles from client to server or server to client in order to optimize total system power. If a server is acting as a Wi-Fi access point (AP), which draws more power than a client mode connection, and there is less power remaining within the server device than another client device, then it may be desirable to make a well-powered client the access point and change the server with less power to a non-access point device. The process is as follows:

In step 302 each device identifies its current state, whether it is a Wi-Fi client or server. If the device is a client, it start a server and mode election process (step 308). If the device is a server, it calculates required throughput for request resources (step 304) and filters supported modulation/frequencies/MIMO modes (step 306).

In step 310, data is exchange over the network among devices on the network to understand their power state, remaining power left in that device, role, capabilities, battery charge, modulation/frequencies, and MIMO support, and current/future tasks to determine how much power is needed to complete the current/future tasks. Based on the exchanged data, a new server can be elected (step 318). The new server can be selected by the clients broadcasting a vote (step 312), manual user selection (step 314), or by the new server being selected based on a comparison of the exchanged data (step 316). The server then determines if the access point should be handed off and to what client.

Next, the device selected to be the new access point would set up a new network in parallel to the current network it is on (step 320). Once this new network is setup, it will communicate on the current network the identifying information and credentials to join the new network.

The other devices will then join the new network (step 322). If they cannot join, this can be communicated back on the old network to resolve the issue manually by the user or automatically based upon a set of rules, contextual engine or the like.

Once the devices are connected to the new network, the old network is shut down: the old server turns off, and the client devices disconnect from the old network by default or proactively (step 324).

If a new server is not elected, but the existing server only changes its mode (step 326), then the clients adapt to the new mode (step 328).

With respect to the system 10 of FIG. 1, a Wi-Fi network consists of an Access Point (AP) device and one or more client devices which connect to the Access Point in order to communicate amongst themselves and to other, non-wireless devices connected to the AP. In the context of the power saving mode, when the WISD 14 is used in server mode, it takes the role of an AP, and the WMCD 12 devices connecting to it are clients. However, the design of the Wi-Fi protocol places a heavier power consumption burden on the AP. Individual clients may enter a low power “sleep” state where they inform the AP that they will not be able to receive traffic until the next occurrence of a network “beacon” that the AP sends on a set interval. The AP bears the responsibility of listening for sleep and wake messages for clients at any time, and as such must keep its receiver and baseband circuitry powered at all times.

However, the WISD 14 may be a portable device that has a smaller battery than the client devices connected to it, and despite its power efficiency there may be situations in which one of the connected WMCDs 12 is better able to fill the role of Access Point. The WMCD 12 may also have a higher power transmitter or be able to transmit at a higher data rate in order to help overcome local bandwidth limitations.

When the WMCD user initiates a connection to the WISD 14, the application may offer the user a choice of which device should fill the role of the AP in the network. Alternatively, the application may make a choice for the user based on power remaining in both devices, and the details of the type of access the user is performing. For instance, if the user chooses to stream a three hour movie but the WISD 14 only has enough power remaining for two hours of streaming, the AP role may be switched to the WMCD 12 in order to ensure that the operation chosen by the user can complete successfully.

If other devices are connected to the WISD 14 while it is in server mode, these devices will need to be informed as to which device now has the AP role so that they can join the correct network. New devices seeking to detect the WISD 14 network will not be able to identify the AP as an WISD network through its MAC address, as the AP will have the MAC address of the WMCD 12.

In addition to the above described techniques for determining the client mode connection of the WISD 14, the application on the WMCD 12 may configure the network name of the WMCD's AP so that it can be identified by other wireless clients as an WISD acting as an AP to provide Wi-Fi services.

If the WMCD 12 acting as the AP no longer needs access to the WISD 14, it may communicate this intention to the WISD 14, whereby the WISD 14 may decide to resume acting as the access point or have another WMCD 12 device act as the access point.

The above use cases can also be applied to other devices whether mobile or fixed. Specifically, they can apply to situations where a mobile device connects to a media player for audio or video. In these cases, there are several ways the devices can discover and connect to each other:

1. The media player device has an AP that beacons when powered on. The mobile device can detect the beacon similar to the previous examples and connect similarly. It would be desirable that the mobile device be able to connect to more than one network (whether to two Wi-Fi networks simultaneously or to different networks simultaneously such as cellular data network and Wi-Fi).

2. The mobile device turns on an AP mode that beacons and the media player device searches for the mobile device's specific, AP MAC address.

In both the situations above, the devices can reconfigure their network configuration to both connect to a different, common network similar to the previous examples. In addition, the networks that are created can be set up as hidden networks with encryption to ensure security and minimal confusion to the user.

Wireless networking technologies, including Wi-Fi, typically have power-saving modes to reduce power-consumption whenever possible. Some of these modes are automatic in the protocol, some are turned on and off by a driver, and some can be implemented in other software domains.

In some configurations, a client device, e.g., WMCD 12, may decide that an operation may require high performance throughput and remotely communicate to the server, e.g., WISD 14, to discontinue various power-saving modes until the client device communicates to re-continue the power saving mode. There can be intelligent decision technology included in the contextual engine 18 or 22 on the client and/or server to help make the decision and/or override, if the client does not provide a re-continue signal within a certain time, after a set of operations, or other contextual decision.

It is also possible for the server to analyze the current communications with one or more clients to make a determination if the power-saving mode should be turned-on or off.

The functionality of the systems, devices, and their respective components, as well as the method steps and blocks described herein may be implemented in hardware, software or firmware executed by a processor, or any suitable combination thereof. The software/firmware may be one or more programs having sets of instructions (e.g., code segments) executable by one or more digital circuits or processors, such as microprocessors, DSPs, embedded controllers, or intellectual property (IP) cores. If implemented in software/firmware, the instructions or code may be stored on one or more computer-readable media, such as a solid-state memory. Computer-readable medium includes any suitable computer storage medium. A storage medium may be any available medium that can be accessed by a computer. By way of example, and not limitation, such computer-readable medium can comprise RAM, ROM, EEPROM, NAND/NOR Flash, CD-ROM, or other solid-state storage, optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable medium.

Other embodiments and modifications of the methods, devices, systems and apparatuses described above will occur readily to those of ordinary skill in the art in view of these teachings. Thus, the foregoing description is illustrative and not restrictive. The invention is to be limited only by the following claims, which cover all such other embodiments and modifications, when viewed in conjunction with the above specification and accompanying drawings. The scope of the invention should, therefore, not be limited to the above description, but instead should be determined with reference to the appended claims along with their full scope of equivalents.

What is claimed is:

1. A method for a first wireless device to select a second wireless device for wirelessly connecting therewith by way of a wireless network, comprising:
detecting, at the first wireless device, a beacon signal transmitted from the second wireless device, the beacon signal including a media access control (MAC) address; and
the first wireless device selecting the second wireless device by applying a set of programmable rules to at least a portion of the MAC address.

2. The method of claim 1, further comprising:
comparing at least a portion of the MAC address to information stored in a database to retrieve additional information about the second wireless device.

3. The method of claim 2, further comprising:
applying the set of programmable rules to the additional information.

4. The method of claim 1, wherein the first wireless device is a network client and the second wireless device is a network server, the method further comprising:
the first wireless device and the second wireless device switching roles so that the first wireless device acts as the network server and the second wireless device acts as the network client.

5. The method of claim 4, further comprising the first wireless device and the second wireless device switching client and server roles based on power consumption of the second wireless device.

6. The method of claim 1, further comprising:
sniffing one or more transmitted MAC packets to determine whether the first wireless device is connected to a second wireless network;
scanning one or more MAC addresses in the MAC packets to identify the second wireless network; and
connecting the second wireless device to the second wireless network identified by the scanning.

7. The method of claim 1, wherein the wireless network is a Wi-Fi network.

8. A computer-readable medium embodying a set of instructions executable by one or more processors, comprising:
code for detecting a beacon signal transmitted from a first wireless device, the beacon signal including a media access control (MAC) address; and
code for applying a set of programmable rules to at least a portion of the MAC address to determine whether to connect a second wireless device to the first wireless device by way of a wireless network.

9. The computer-readable medium of claim 8, further comprising:
code for comparing at least a portion of the MAC address to information stored in a database to retrieve additional information about the first wireless device.

10. The computer-readable medium of claim 8, further comprising:
code for applying the set of programmable rules to the additional information.

11. The computer-readable medium of claim 8, wherein the first wireless device is a network server and the second wireless device is a network client, the computer-readable medium further comprising:
code for causing the first wireless device and the second wireless device to switch roles so that the first wireless device acts as the network client and the second wireless device acts as the network server.

12. The computer-readable medium of claim 11, further comprising:
code for switching the first wireless device's and the second wireless device's server and client roles based on power consumption of the first wireless device.

13. The computer-readable medium of claim 8, further comprising:
code for sniffing one or more transmitted MAC packets to determine whether the second wireless device is connected to a second wireless network;
code for scanning one or more MAC addresses in the MAC packets to identify the second wireless network; and
code for connecting the first wireless device to the second wireless network identified by scanning.

14. The computer-readable medium of claim 8, wherein the wireless network is a Wi-Fi network.

15. A system, comprising:
a first wireless device configured to transmit a wireless beacon signal, the beacon signal including a media access control (MAC) address; and
a second wireless device configured to detect the beacon signal and to determine whether to wirelessly connect to the first wireless device by applying a set of programmable rules to at least a portion of the MAC address.

16. The system of claim 15, wherein the second wireless device is further configured to compare at least a portion of the MAC address to information stored in a database to retrieve additional information about the first wireless device.

17. The system of claim 16, wherein the second wireless device is further configured to apply the set of programmable rules to the additional information.

18. The system of claim 16, wherein the first wireless device is a network server and the second wireless device is a network client, and wherein the first wireless device and the second wireless device are further configured to switch roles so that the first wireless device acts as the network client and the second wireless device acts as the network server.

19. The system of claim 18, wherein the first wireless device and the second wireless device switch client and server roles based on power consumption of the first wireless device.

20. The system of claim 15, wherein the first wireless device is further configured to:
sniff one or more transmitted MAC packets to determine whether the second wireless device is connected to a second wireless network;
scan one or more MAC addresses in the MAC packets to identify the second wireless network; and
connect to the second wireless network identified by the scanning.
